(19) United States
(12) Patent Application Publication
(10) Pub. No.: US 2007/0136163 A1
(43) Pub. Date: Jun. 14, 2007

(54) Systems and methods for providing financing information based on a vehicle identification number

(75) Inventor: Ryan B. Bell, Plano, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/302,216

(22) Filed: Dec. 14, 2005

(51) Int. Cl. G06Q 40/00

(52) U.S. Cl. 705/35; 705/38

(57) ABSTRACT

Systems and methods allow a customer to obtain a monthly payment and view possible financing options while shopping for a vehicle on a dealership's lot. A server may receive a VIN, calculate a monthly payment based on customer parameters, and transmit a message to a wireless device being used by the customer. The message may provide a monthly payment amount and possible financing options for a particular vehicle. The customer may also may input parameters, such as a down payment and an amount of a trade-in, if applicable, so that the parameters are taken into consider when determining financing options.

### TECHNICAL FIELD

Embodiments consistent with the present invention provide systems and methods for determining financing information for a vehicle based on a vehicle identification number (VIN). In particular, embodiments consistent with the present invention use a wireless device to read or receive, as input, a VIN in order to determine financing information for a customer.

### BACKGROUND

When shopping for a new or used vehicle, a customer typically browses inventory that is displayed on a dealership lot. Once a customer identifies a vehicle of interest, in order to obtain financing information for that vehicle, the customer must travel inside the dealership to visit the financing department. A salesperson in the financing department then determines financing options that are available for the identified vehicle. For example, the salesperson may determine an interest rate and time period for repayment of the loan, an amount of a down payment and/or trade in amount, and use the information to calculate a monthly loan payment.

Once the salesperson provides the customer with financing information for the vehicle, the customer may determine that the monthly loan payment exceeds the customer's budget. As a result, the customer may decide to continue shopping for a vehicle on the lot. Alternatively, the customer may decide that he or she can in fact afford a more expensive vehicle or may continue shopping in order to locate a car with a desired option because he or she can afford a larger monthly payment. As one can readily understand, for a variety of reasons, customers frequently return to the dealership lot to examine additional dealership inventory. Once a customer locates another vehicle of interest, the customer must then return to the financing department to determine financing options for the newly selected vehicle. Traveling back and forth between the dealership lot can be time consuming for the customer. Furthermore, uncertainty as to whether the customer can afford a particular vehicle may also consume more time because the customer is unaware of how much he or she can afford until after selecting a vehicle from the lot and returning to the financing department to obtain a monthly payment.

There is therefore a need for systems and methods that would allow the customer to receive financing information, including a monthly payment amount, without requiring the customer to travel from the dealership lot to the financing department. Such systems and methods would allow the customer to identify a vehicle, submit a VIN for the vehicle, and receive financing options, including a monthly payment, all while shopping in the dealership lot. As a result, the customer could more efficiently shop for and compare vehicles and save time by avoiding repeated trips to the financing department. Moreover, the customer may gain a better sense of which vehicles the customer can afford to purchase because the customer can rapidly learn a monthly payment amount for any vehicle on the dealership lot.

### SUMMARY

Consistent with an embodiment of the present invention, a method provide financing information based on a vehicle identification number obtained from a vehicle by a wireless device. The method comprises receiving over a network, from the wireless device, the vehicle identification number; determining financing information based on the vehicle identification number; and transmitting over the network, to the wireless device, the determined financing information.

Consistent with another embodiment of the present invention, a system determines financing information. The system comprises a processor; and a server. The server receives a vehicle identification number from a wireless device, determines a cost of a vehicle assigned the vehicle identification number, and determines financing information for the vehicle.

Consistent with yet another embodiment of the present invention, a wireless device determines financing information based on a vehicle identification number obtained from a vehicle. The wireless device comprises a processor; and a software module executing instructions that determine financing information based on the vehicle identification number received by the wireless device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention. In the drawings:

FIG. 1 is a diagram of an exemplary system for providing vehicle financing information, consistent with an embodiment of the present invention;

FIG. 2 is a flow chart of an exemplary method for providing vehicle financing information, consistent with an embodiment of the present invention;

FIG. 3 is a flow chart of an exemplary method for determining vehicle financing information, consistent with an embodiment of the present invention; and

FIG. 4 is a flow chart of an exemplary method for estimating vehicle financing information, consistent with an embodiment of the present invention.

### DESCRIPTION OF THE EMBODIMENTS

Embodiments consistent with the present invention provide systems and methods that allow a customer to obtain an amount of a monthly payment and view possible financing options while shopping for a vehicle on a dealership lot. For example, a server may receive a VIN, calculate a monthly payment based on customer parameters, and transmit a message to the customer. The message may provide possible financing options for the customer, including a monthly payment amount.

To obtain the VIN, a customer may use a handheld wireless device to, for example, scan a VIN bar code or may input the VIN into the wireless device. For example, a customer on a dealership lot, equipped with the wireless device, may scan a VIN bar code from a vehicle or a vehicle price sticker. VIN bar codes are typically included with the VIN, which is often written on a plate that is mounted on the dashboard area and/or is visible through the front windshield of a vehicle. A VIN may also be listed on a window sticker of a vehicle, where the sticker may not have a bar code. The customer may also may input parameters into the wireless device, such as a down payment and an amount of a trade-in, if applicable, so that the parameters are taken into consideration when determining financing options. In other embodiments, the server may access parameters that the customer has previous submitted to a financing company (e.g., when the customer completed a loan application), that are used as part of calculating a monthly payment.

Furthermore, the wireless device may be provided to the customer by the dealership or a financing company and may include, for example, a bar-code reader. Alternatively, the wireless device may be a personal data assistant (PDA), cell phone, or any other appropriate handheld device belonging to the customer. As yet another alternative, the dealership or financing company may provide a scanner or reader that may be attached to a customer's wireless device via a data port of the wireless device. In still yet another alternative, a wireless device may not include a scanner or reader and the customer may instead input the VIN using a keypad on the wireless device or by speaking voice commands.

Once the VIN is obtained, the wireless device may communicate with the server over a network, and transmit data, including the VIN, to identify the vehicle to the server. The server may determine financing information, such as, for example, an expected monthly payment for the vehicle corresponding to the VIN. Other parameters specified by the customer, such as down payment and trade in amount, may also be used in determining the price of the vehicle. Furthermore, the server may transmit a message to the wireless device indicating a monthly payment and possible financing options for a particular vehicle or possible financing options for the customer that are not tied to a specific vehicle.

When the wireless handheld device transmits the VIN to the server, the server may also use the VIN to access a dealership management system to retrieve information describing the vehicle. For example, if the vehicle is used, the condition of the car may be obtained from a dealership management system server. Other information, such as vehicle mileage, may also be obtained from the dealership management system server. Alternatively, the server may access one or more servers maintained by aggregator companies that collect data from multiple dealerships. Aggregator servers may maintain data for a group of dealerships based on region, for example.

Once the vehicle has been identified, the server may evaluate the fair market value of the vehicle or obtain the dealer's price. Financing information, such as an interest rate, period for repayment of the loan, and monthly payment, may then be determined by the server and transmitted to the wireless device. Furthermore, once a customer has negotiated a price with the dealer, the system may receive the negotiated price from the handheld device in order to update the financing information and compute a revised monthly payment. A customer may also input a down payment and an amount of any trade-in so that the financing information provided to the customer is adjusted accordingly.

Furthermore, when the customer is shopping for a used vehicle, the customer may also specify a condition of the vehicle using the handheld device or, alternatively, the condition may be determined through a series of interactive questions presented to the customer via the handheld device. For example, the customer may be asked whether the vehicle has noticeable damage. This information may be transmitted to the server from the wireless device, which is then used when determining the cost of the vehicle. Consistent with embodiments of the present invention, a customer may therefore receive specific financing information for a particular used vehicle as well.

Reference will now be made to exemplary embodiments of the invention, examples of which are illustrated in the accompanying drawings. Wherever possible, the same reference numbers will be used throughout the drawings to refer to the same or like parts.

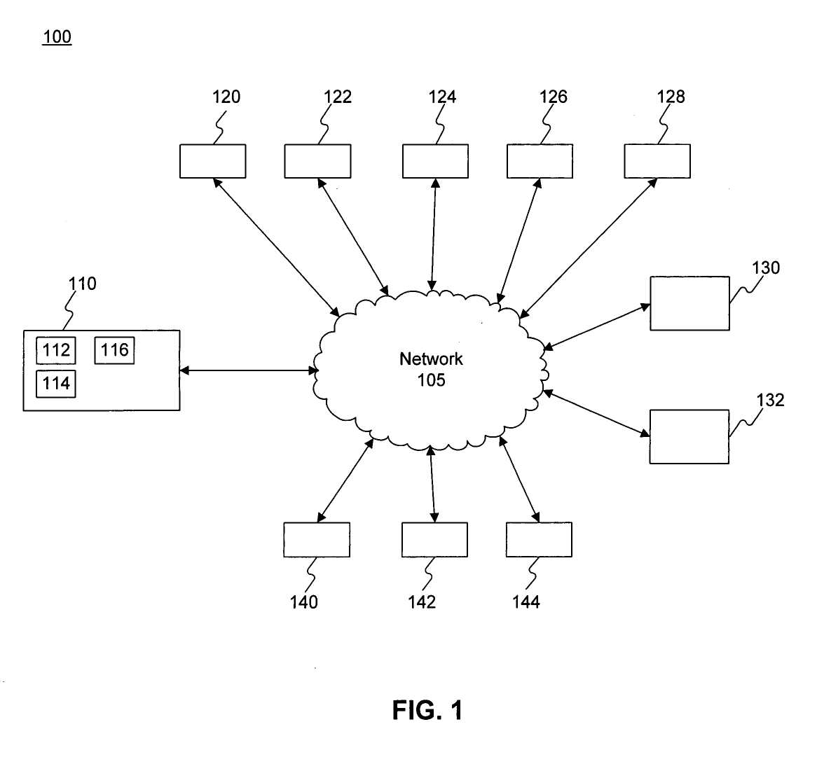

FIG. 1 is a diagram of an exemplary system 100 for providing vehicle financing information, consistent with an embodiment of the present invention. System 100 includes a server 110, with a CPU 112, a memory 114, and a storage medium 116. Server 110 may be operated by a financing company involved in the business of providing vehicle financing and may be connected to a network 105. Software in memory 114 preferably implements a program for providing vehicle financing information to customers located at wireless devices 140-144. For example, memory 114 may store programming modules (not shown) for executing instructions to obtain data describing vehicles from dealer management servers 120-128 and/or aggregator servers 130-132. Storage medium 116 may include a database (not shown) storing data pertaining to customers of the financing company that operates server 110.

For example, storage medium 116 may store data already obtained from customers, such as name, address, income, and a credit score. This data may be available because, in advance of traveling to a dealership, a customer may have already submitted electronically via a web site identification information, a down payment amount intended to be used to purchase a vehicle, and/or a trade-in amount. Accordingly, server 110 may retrieve the data from storage medium 116 for use in calculating financing information for a vehicle of interest at a later time.

Network 105 provides communications between the various components in system 100, such as server 110, wireless devices 140-144, dealer management system (DMS) servers 120-128, and aggregator servers 130-132. Network 105 may be a shared, public, or private network and may encompass a wide or local area. Furthermore, network 105 may be implemented through any suitable combination of wired and/or wireless communication networks. By way of example, network 105 may be implemented through a wide area network (WAN), local area network (LAN), an intranet, or the Internet.

Wireless devices 140-144 allow a user to send and/or receive information to and from server 110. Wireless devices 140-144 may be any type of appropriate device for communicating with server 110 over network 105. For example, wireless device 140 may be a PDA running a program for communicating with server 105, while wireless device 142 may be a cellular phone. Wireless device 144 may be any appropriate handled device, such as a Blackberry, for example. Furthermore, any of wireless devices 140-144 may include a built-in bar code scanner for scanning a VIN from a vehicle, or any other type of reader for reading a VIN. Wireless devices 140-144 may also include an LCD display or the like, for example, for displaying data transmitted to and from server 110. Furthermore, a customer may operate a web browser or software running on one of wireless devices 140-144 to enter information that is transmitted to server 110. Although in the above example, any of wireless devices 140-144 may include a bar code scanner, a bar code scanner may be instead attached to any of wireless devices 140-144 by using data ports of wireless devices 140-144.

Dealer management system (DMS) servers 120-128 may store data relating to vehicle inventory at a particular dealership. For example, DMS servers 120-128 may store vehicle information describing vehicles in a particular dealership's inventories. Vehicle information may include the VIN, year, make, model, and trim of the vehicle, any options included in the vehicle, as well as vehicle mileage, vehicle condition, manufacturer's suggested retail price (MSRP) information, and invoice price information. In an embodiment consistent with the present invention, one or more DMS servers 120-128 may communicate directly with server 110 over network 105 to provide vehicle information requested by server 110. Alternatively, server 110 may periodically retrieve vehicle information from one or more of DMS servers 120-128 and store the vehicle information in a database (not shown) included in storage medium 116.

DMS servers 120-128 may also interface with one or more aggregator servers 130-132. Aggregator servers 130-132 may have agreements with dealerships to share vehicle information. Based on these agreements, aggregator servers 130-132 pool data from one or more of DMS servers 120-128 into central storage repositories. Each of aggregator servers 130-132 may, at the close of business each day, update a database (not shown) with data from DMS servers 120-128. For example, aggregator server 130 may have an agreement with DMS servers 120-122 so that aggregator server 130 may obtain data from DMS servers 120-122. Similarly, aggregator server 132 may have an agreement with DMS servers 124-126 to obtain data from DMS servers 124-126. Data may be updated on a periodic basis, such as a hourly or daily, for example.

As shown in FIG. 1, an exemplary number of DMS servers are connected to network 105. One of ordinary skill in the art will recognize that in order to interface with all dealerships, server 110 may need to communication with hundreds of DMS servers over network 105. Therefore, in order to manage the ability of server 110 to obtain vehicle information, server 110 may instead access a smaller number of aggregator servers 130-132. It is generally estimated that aggregator servers may cover approximately eighty percent of dealerships in the United States. Therefore, in lieu of accessing each of DMS servers 120-126, server 110 may obtain data from aggregator servers 130-132.

In the example described with respect to FIG. 1, DMS server 128 may not have an agreement with any of aggregator servers 130-132. For situations where a vehicle of interest is located at the dealership corresponding to DMS server 128, server 110 may obtain information directly from DMS server 128. Alternatively, if DMS server 128 is not accessible by server 110, a technique called “VIN explosion,” which is discussed below in further detail, may be used to estimate vehicle information.

Accordingly, as described with respect to FIG. 1, system 100 provides an arrangement whereby server 110 may communicate over network 105 with DMS servers 120-128 to obtain vehicle information. Alternatively, or in addition, server 110 may communicate over network 105 with aggregator servers 130-132 to obtain vehicle information. Server 110 may also communicate over network 105 with customers using wireless devices 140-144. For example, wireless devices 140-144 may transmit a VIN for a vehicle of interest and/or other information to server 110. In response, server 110 may transmit financing information for the vehicle of interest, or financing information for the customer that is not tied to a specific vehicle, to one of wireless devices 140-144.

Still further, functionality and data provided by server 110 may be incorporated into wireless devices 140-144. For example, one or more of wireless devices 140-144 may include a processor (not shown) for implementing software modules that perform functionality similar to that discussed above with respect to server 110. Furthermore, one or more of wireless devices 140-144 may include a database (not shown) storing information obtained over network 105 from any of DMS servers 120-128 and/or aggregator servers 130-132.

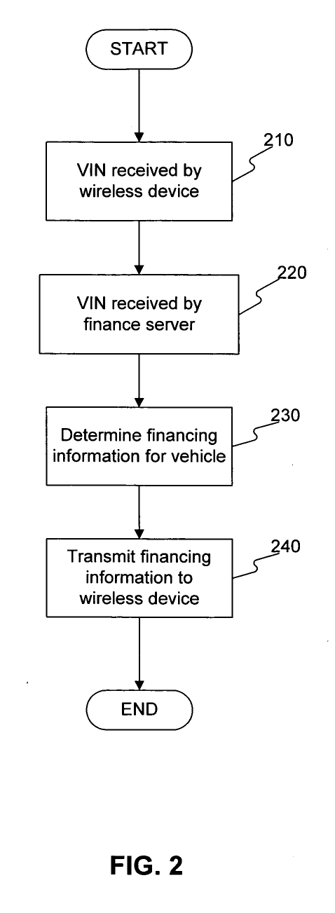

FIG. 2 is a flow chart 200 of an exemplary method for providing vehicle financing information, consistent with an embodiment of the present invention. In the method shown in flow chart 200, financing information is provided to a customer based on a VIN, which may be transmitted from a wireless device to a server. The server determines financing information, such as a monthly payment for the vehicle, and transmits the financing information to the wireless device.

At the start of the process, in step 210, a customer uses a bar code scanner attached to, or incorporated as part of, a wireless device to scan a VIN from a vehicle. For example, the wireless device may be any of wireless devices 140-144, as discussed above in connection with FIG. 1. The VIN may be transmitted via radio frequency from the wireless device to, for example, an antenna at a communication tower. The communication tower may be connected to network 105, for example. A message is then sent to, for example, server 110 over network 105. The message may include the VIN number and information identifying the wireless device, for example. Information identifying the wireless device may include a user name or telephone number.

In some embodiments, only the VIN number may be transmitted from the wireless device. In other embodiments, the VIN number and identifying information may be transmitted from the wireless device. In still yet other embodiments, the message may also include additional information entered by the user into the wireless device, such as an interest rate or a time period for repayment of a loan.

In step 220, server 110 may receive the message over network 105 from a wireless device. The message, as discussed above, may include the VIN number, information identifying the wireless device, and any additional information entered by the user. Next, in step 230, using the VIN, server 110 may access one or more of DMS servers 120-128 to obtain vehicle information. The DMS server for a particular dealership may be determined based on the location of the wireless device, for example, or based on information previously transmitted by the wireless device. For example, the user may have previously sent a message specifying the dealership or a ZIP code for the area where the user is located. Alternatively, server 110 may have stored in storage medium 116 vehicle information pertaining to a particular dealership. In yet another alternative, server 110 may access one or more aggregator servers 130-132 to obtain vehicle information based on the VIN. Vehicle information may include year, make, model, and trim of the vehicle, any options included in the vehicle, vehicle mileage, vehicle condition, manufacturer's suggested retail price (MSRP) information, and invoice price information, for example.

Next, in step 240, server 110 may determine financing information for the vehicle. For example, server 110 may compute an expected market value for the vehicle based on the location of the dealership. Server 110, based on the information identifying the wireless device, may also identify the customer using the wireless device. Based on a profile of the customer stored, for example, in storage medium 116, server 110 may determine an interest rate and period for repayment of the loan. Server 110 may also retrieve, from storage medium 116, for example, a down payment amount previously provided by the customer and/or a trade-in value previously provided by the customer. Server 110 may also retrieve from a database information describing incentives for the region. For example, server 110 may incorporate incentives for the region into the vehicle price and may also compute the applicable tax, tag, and title fees, to arrive at an expected loan amount. Once an expected loan amount for the vehicle is determined, server 110 may calculate a monthly payment. Furthermore, server 110 may also determine financing information for the customer based on, for example, the customer profile, that is not tied to a specific vehicle. For example, server 110 may determine financing information, such as a loan amount and terms of a loan, for which the customer is pre-approved.

When a customer is shopping for a used vehicle, server 110 may access, over network 105, a report indicating whether the vehicle has been in an accident or has had one owner or multiple owners. This information may be used by server 110 when determining an expected cost of a used vehicle.

In step 240, server 110 transmits a message to one of wireless devices 140-144 over network 105. The message may include financing information, such as the interest rate and time period for repayment of the loan, a monthly payment amount, and any other information pertaining to the loan. For example, the message may provide directions for the user to accept the loan. Alternatively, the financing information may indicate that the customer is pre-approved for a loan up to a particular amount for any vehicle.

In other embodiments consistent with the present invention, in step 210, the VIN may be manually input into a wireless device by the customer. For example, in a situation where the customer has a cellular phone, or PDA, but does not have a scanner built-in or attached to the device, the user may manually input the VIN using a keypad of the wireless device or by speaking voice commands. Furthermore, in other embodiments consistent with the present invention, when the user scans the VIN with a wireless device including or equipped with a bar code scanner or enters the VIN manually in step 210, the user may also supply additional information. For example, the user may manually input a down payment and/or trade-in amount, which is transmitted with the VIN to server 110.

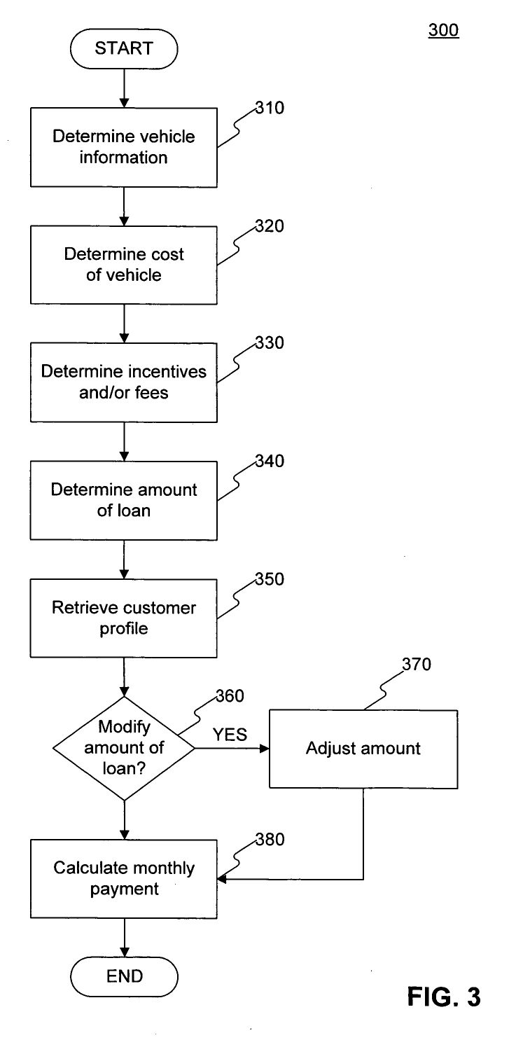

FIG. 3 is a flow chart 300 of an exemplary method for determining vehicle financing information, consistent with an embodiment of the present invention. In the method shown in flow chart 300, financing information is determined based on a VIN that has been transmitted from a wireless device to a server. Accordingly, FIG. 3 is an exemplary embodiment further specifying steps taken as part of step 240, which was generally described with respect to FIG. 2.

At the start of the process, in step 310, vehicle information is determined based on a VIN. The VIN may have been transmitted to server 110, for example, from one of wireless devices 140-144. Using the VIN, server 110 may determine vehicle information that is stored in storage medium 116 of server 110, or may access one of DMS servers 120-128 or aggregator servers 130-132.

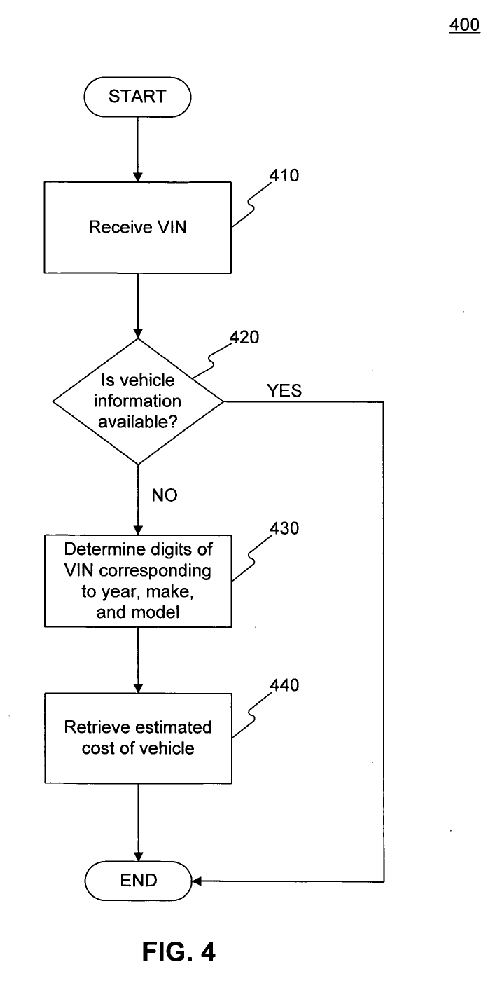

For example, server 110 may already have information pertaining to the vehicle corresponding to the VIN stored in a database. Alternatively, server 110 may communicate over network 105 with a DMS server corresponding to a particular dealership to retrieve vehicle information. The dealership where a customer is shopping may be determined by, for example, examining the location of the handheld device or may have been previously specified by the customer. As still yet another alternative, server 110 may retrieve data for the vehicle from an aggregator server. In the event that the DMS server for the appropriate dealership is unavailable and/or the VIN is not located in an aggregator server, a VIN explosion technique may be used to estimate financing information for the vehicle. VIN explosion is described in more detail in connection with FIG. 4.

Next, in step 320, server 110 may compute a market value for the vehicle based on specifications of the vehicle and/or the location of the dealership, for example. For example, the specifications of the vehicle may include all of the options of the vehicle so that market value for each option can be determined to arrive at a total market value. Accordingly, server 110 may determine a market value for a vehicle having a set of specifications corresponding to the vehicle of interest.

Furthermore, when a customer is shopping for a used vehicle, server 110 may retrieve a report, such as from an external server that indicates whether the vehicle has been in an accident or has had one owner or multiple owners. This information may be used by server 110 when determining an expected value of a used vehicle.

Next, in step 330, server 110 may also take into account any incentives for the region, as well as compute the applicable tax, tag, and title fees, to arrive at a total vehicle cost. Furthermore, the total vehicle cost may be modified by the user at a later time should the user have negotiated a price that differs from the one initially determined by server 110.

In step 340, server 110 may determine an initial amount of the loan. The initial amount of the loan may take into consideration incentives that are available in the region and additional fees such as tax, tag, and title fees.

Next, in step 350, server 110 may determine customer information. For example, server 110, based on information identifying the wireless device, may retrieve a customer profile. Based on the profile of the customer, server 110 may determine an interest rate and period for repayment of the loan, for example. Server 110 may also retrieve, from storage medium 116, for example, when available, a down payment previously provided by the customer and/or a trade-in value previously provided by the customer.

Turning to step 360, server 110 evaluates whether to modify the amount of the loan to take into consideration a down payment and/or trade-in value. If the customer has not provided a down payment and/or trade-in value, the initial loan amount is deemed the total loan amount and the process proceeds to step 380. However, if the customer has supplied a down payment and/or trade-in value, the process proceeds to step 370.

In step 370, the amount of the loan is adjusted to reflect the down payment and/or trade-in value to arrive at the total amount of the loan, and the process proceeds to step 380. Accordingly, the total amount of the loan may reflect all of the additional costs that the buyer will incur as well as any credits or payments that the buyer will make towards the purchase of the vehicle.

In step 380, server 110 calculates an amount of a monthly payment. The monthly payment amount and other information pertaining to the loan may then be transmitted to the user's wireless device.

FIG. 4 is a flow chart 400 of an exemplary method for estimating vehicle financing information, consistent with an embodiment of the present invention. In the method shown in flow chart 400, financing information is estimated based on a VIN that has been transmitted from a wireless device to a server. As discussed above, in the event that server 110 cannot access a DMS server for a particular dealership and/or the inventory of a particular dealership is not included in an aggregator server, then the following process may be used to estimate financing information for a vehicle.

At the start of the process, in step 410, server 110 receives a VIN. Next, in step 420, server 110 determines whether vehicle information is available for the VIN. In making the determination, server 110 may examine its database, or may access a DMS server or an aggregator server. If vehicle information corresponding to the VIN is available, the process ends. However, if vehicle information corresponding to the VIN is not available, the process proceeds to step 430.

In step 430, digits in the VIN are examined to determine make, model, and year of the vehicle. This process is termed “VIN explosion,” because certain digits of a VIN correspond to the make, model, and year of the vehicle. While VIN explosion will not pinpoint all of the options of a particular vehicle, this process may serve as a good estimate when other alternatives are not available. Next, in step 440, an estimated cost of the vehicle is determined based on the make, model, and year information. The estimated cost of the vehicle may then be used consistent with the above methodologies. In the event that an estimated cost of the vehicle is used, a message transmitted from server 110 to one of wireless devices 140-144 may include a notation that the price was estimated because data specific to the vehicle was unavailable.

Accordingly, systems and methods consistent with the invention allow a customer equipped with a wireless device to obtain a monthly payment and view possible financing options while shopping for a vehicle on a dealership's lot. For example, a server may receive a VIN, calculate a monthly payment based on customer parameters, and transmit a message to the customer. The message may provide a monthly payment amount and possible financing options for a particular vehicle. The customer may also input parameters, such as a down payment and an amount of a trade-in, if applicable, so that the parameters are taken into consideration when determining financing options.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A method for providing financing information based on a vehicle identification number obtained from a vehicle by a wireless device, the method comprising:
receiving over a network, from the wireless device, the vehicle identification number;
determining financing information based on the vehicle identification number; and
transmitting over the network, to the wireless device, the determined financing information.

2. The method of claim 1, wherein the wireless device reads a bar code of the vehicle identification number with a scanner.

3. The method of claim 1, wherein the wireless device is a cellular phone or a PDA.

4. The method of claim 1, wherein determining the financing information based on the vehicle identification number comprises:
accessing a dealer management server or an aggregator server to determine an invoice price for a vehicle assigned the vehicle identification number.

5. The method of claim 1, wherein determining the financing information based on the vehicle identification number comprises:
accessing a dealer management server or an aggregator server to determine specifications of a vehicle assigned the vehicle identification number; and
determining a market value of the vehicle based on the specifications.

6. The method of claim 1, wherein determining the financing information comprises:
determining a loan amount for a vehicle assigned the vehicle identification number.

7. The method of claim 6, comprising:
reducing the loan amount by a down payment amount or a trade-in amount.

8. The method of claim 6, comprising:
determining a monthly payment amount based on the loan amount, an interest rate, and a term of the loan.

9. The method of claim 1, wherein determining the financing information comprises:
determining a loan amount of a vehicle assigned the vehicle identification number; and
determining an amount of a monthly payment based on the loan amount, an interest rate, and a time period of the loan.

10. The method of claim 1, wherein determining the financing information comprises:
receiving information identifying a customer operating the wireless device.

11. A system for determining financing information, comprising:
a processor; and
a server, wherein the server receives a vehicle identification number from a wireless device, determines a cost of a vehicle assigned the vehicle identification number, and determines financing information for the vehicle.

12. The system of claim 11, wherein the server determines a cost of the vehicle by accessing a dealer management server or an aggregator server to determine an invoice price for a vehicle assigned the vehicle identification number.

13. The system of claim 11, wherein the server determines the cost of the vehicle by accessing a dealer management server or an aggregator server to determine specifications of the vehicle and computes a market value of the vehicle using the specifications.

14. The system of claim 11, wherein the server calculates a loan amount based on the cost of the vehicle.

15. The system of claim 14, wherein the loan amount is reduced by a down payment amount or a trade-in amount.

16. The system of claim 14, wherein the server determines a monthly payment amount based on the loan amount.

17. The system of claim 16, wherein the server transmits the monthly payment amount over a network to the wireless device.

18. The system of claim 11, wherein the server receives information identifying a customer operating the wireless device.

19. A wireless device for determining financing information based on a vehicle identification number obtained from a vehicle, the wireless device comprising:
a processor; and
a software module executing instructions that determine financing information based on the vehicle identification number received by the wireless device.

20. The wireless device of claim 19, further comprising a scanner, and wherein the wireless device receives the vehicle identification number by reading a bar code of the vehicle identification number with the scanner.

21. The wireless device of claim 19, further comprising a data port for connecting the wireless device to a scanner, wherein the wireless device receives the vehicle identification number by reading a bar code of the vehicle identification number with the scanner.

22. The wireless device of claim 19, wherein the wireless device determines a loan amount of a vehicle assigned the vehicle identification number.

23. The wireless device of claim 19, wherein the wireless device receives information identifying a customer operating the wireless device.
